(19) United States
(12) Patent Application Publication
(10) Pub. No.: US 2024/0185727 A1
(43) Pub. Date: Jun. 6, 2024

(54) METHOD FOR REMOTELY CONTROLLING THE FLIGHT OF AN AIRCRAFT, AND ASSOCIATED COMMUNICATION MODULE

(71) Applicant: THALES, MEUDON (FR)

(72) Inventors: Denis RICAUD, TOULOUSE (FR); Johan BOYER, TOULOUSE (FR); Laurent FREDE, TOULOUSE (FR)

(21) Appl. No.: 18/527,324

(22) Filed: Dec. 3, 2023

(30) Foreign Application Priority Data
Dec. 6, 2022 (FR) 2212844

(51) Int. Cl. G08G 5/00

(52) U.S. Cl. CPC G08G 5/0039; G08G 5/0013; G08G 5/0021; G08G 5/0056

(57) ABSTRACT

A method for remotely controlling the flight of an aircraft following a first flight plan, the aircraft includes a communication module connected to a flight management centre of the aircraft, the communication module being suitable for allowing a communication between a terrestrial communication station and the aircraft, the method comprising the following steps:
determining, in the terrestrial communication station, an incapacity of the pilot or pilots of the aircraft,
using the communication module, receiving a first signal that has been coded using a predetermined code and transmitted by the terrestrial communication station, and then decoding the first signal using the predetermined code, which has previously been stored in the communication module,
after the first signal has been decoded, sending, using the communication module, a command to the flight management centre prompting a second flight plan to be followed by the aircraft.

### CROSS-REFERENCE TO RELATED APPLICATION

This application claims priority to foreign French patent application No. FR 2212844, filed on Dec. 6, 2022, the disclosure of which is incorporated by reference in its entirety.

### FIELD OF THE INVENTION

The present invention relates to the field of avionics and more particularly that of avionics for commercial aviation, and to the field of communications with air traffic control or ATC.

### BACKGROUND

In commercial transport aviation, or more generally in any avionics platform operated with a single pilot (hereinafter called a “monopilot”), a major risk is that of incapacitation of the operating pilot. “Incapacitation” is understood here to mean a state in which the pilot is no longer capable of pursuing the mission. This state may be due to physical problems in the pilot (for example loss of consciousness) or to inappropriate behaviour by the pilot.

At present, the problem of a pilot's incapacitation is not dealt with in the field of commercial aviation because it is based on a crew of two pilots on the vast majority of aeroplane or helicopter platforms.

The development of avionics solutions that allow the aircraft to be diverted from its initial flight plan and that are compatible with “monopilot” operations requires the ability to automatically manage the situation of incapacitation of the pilot, for example by pursuing or diverting the mission automatically, without the assistance of the pilot, to a point of landing and stopping the platform and the engines.

For general aviation, on some aircraft and in some avionics solutions, there are emergency functions that are always able to be activated aboard the aircraft manually in order to automatically divert the mission.

However, the activation of these emergency functions from aboard the aircraft could be faulty in some cases for the same reasons as those that led to the pilot's incapacitation. For example, this fault could be due to a common external cause: depressurization, explosion or mechanical shock damaging the systems for detecting an incapacitation situation (manual and automatic).

Alternatively, this fault could be due to inconsistent or inappropriate behaviour by the pilot, jeopardizing pursuit of the mission under acceptable safety conditions.

In these two cases, it would then not be possible or realistic to expect activation of the emergency functions aimed at diverting the aircraft from its initial flight plan.

It is therefore necessary to develop a solution allowing the activation of an emergency function aimed at diverting the aircraft from its initial flight plan that overcomes the aforementioned problems of the prior art.

### SUMMARY OF THE INVENTION

To this end, a subject of the invention is a method (and an associated communication module) for remotely controlling the flight of an aircraft comprising a communication module connected to a flight management centre of the aircraft. In the method of the invention, the communication module allows a coded communication with a terrestrial communication station. The decoding, using the communication module, of a first signal transmitted by the terrestrial communication station after the latter has detected incapacitation of the pilot brings about the sending of a command to the flight management centre. This command then prompts a certain number of automatic reflexes, including a second flight plan being engaged and followed by the aircraft. Thus, the solution allows diversion of the aircraft from its initial flight plan to be prompted remotely along with all the systems and associated means, in a manner protected via the communication module.

To this end, one subject of the invention is a method for remotely controlling the flight of an aircraft following a first flight plan, the aircraft comprising a communication module connected to a flight management centre of the aircraft, the communication module being suitable for allowing a communication between a terrestrial communication station and the aircraft, the method comprising the following steps:
A. determining, in the terrestrial communication station, an incapacity of the pilot or pilots of the aircraft
B. using the communication module, receiving a first signal that has been coded using a predetermined code and transmitted by the terrestrial communication station, and then decoding the first signal using the predetermined code, which has previously been stored in the communication module,
C. after the first signal has been decoded, sending, using the communication module, a command to the flight management centre prompting a second flight plan to be followed by the aircraft.

According to one embodiment, the second flight plan comprises landing the aircraft at a different airport from a landing airport of the first flight plan. Preferably, a determination of the second airport in step C is performed on the basis of localization data provided by a localization sensor connected to the flight management centre and/or on the basis of data comprising airport selection criteria and appropriate mode of conduct of the aeroplane with regard to the second selected airport.

According to one embodiment, the flight management centre is configured so that the pilot or pilots is/are unable to change a flight parameter of the aircraft during step C.

According to one embodiment, the method of the invention comprises a subsequent step D of:
determining, in the terrestrial communication station, a non-incapacity of the pilot or pilots of the aircraft,
receiving, using the communication module, a second signal that has been coded using the predetermined code and transmitted by the terrestrial communication station, and then decoding the second signal using the predetermined code, which has previously been stored in the communication module,
after having decoded the second signal, sending, using the communication module, an additional command to the flight management centre that involves reproviding the pilot or pilots with the capacity to change a flight parameter of the aircraft.

According to one embodiment, the first signal is received by the communication module by way of an exclusive communication channel between the aircraft and the terrestrial communication station, the exclusive communication channel being protected by the predetermined code.

According to one embodiment, the first signal is received by the communication module by way of a clear communication channel that is common to a plurality of other aircraft in order to communicate with the terrestrial communication station, the first signal being a voice message comprising the predetermined code, the decoding of the first signal then being performed by voice recognition of the predetermined code included in the first signal.

According to one embodiment, the method of the invention comprises a step BC in between step B and step C of preparing and then displaying the second flight plan on a screen of the aircraft visible to the pilot or pilots, step C being implemented after step BC only after a predetermined time.

According to one embodiment, the aircraft comprises a single pilot.

According to one embodiment, the determination of the incapacity is performed on the basis of at least one piece of information chosen from the following list: a heading of the aircraft, an altitude of the aircraft, a speed of the aircraft, an overflight of a prohibited area by the aircraft, a loss of communication between the communication station and the aircraft, or an incapacity to establish a communication,

According to one embodiment, the determination of the incapacity is performed on the basis of at least one piece of information that is transmitted by the aircraft and representative of vital parameters of the pilot or pilots.

Another subject of the invention is a communication module aboard an aircraft, the communication module being connected to a flight management centre of the aircraft and being suitable for allowing a communication between a terrestrial communication station and the aircraft, and being suitable for implementing the following steps when the aircraft follows a first flight plan:
A. receiving a first signal that has been coded using a predetermined code and transmitted by the terrestrial communication station, and then decoding the first signal using the predetermined code, which has previously been stored in the communication module,
B. after the first signal has been decoded, sending, using the communication module, a command to the flight management centre of the aircraft prompting a second flight plan to be followed by the aircraft.

According to one embodiment, the communication module is a SELCAL module or a DATALINK module.

According to one embodiment, the communication module is suitable for transmitting, to the terrestrial communication station, at least one piece of information that is representative of an incapacity of the pilot or pilots of the aircraft.

According to one embodiment, only before the aircraft takes off, the communication module is configurable to not implement step B after step A.

### BRIEF DESCRIPTION OF THE DRAWINGS

Other features, details and advantages of the invention will become apparent from reading the description provided with reference to the appended drawings, which are provided by way of example and in which, respectively:

FIG. 1 shows a schematic illustration of the method of the invention for remotely controlling the flight of an aircraft,

FIG. 2 shows a schematic illustration of the communication module according to the invention, which is aboard the aircraft and in particular suitable for implementing the method of the invention,

FIG. 3 shows a schematic illustration of an embodiment M2 in which the step of determination of the incapacity is performed on the basis of at least one piece of information that is transmitted by the aircraft and representative of vital parameters of the pilot or pilots,

FIG. 4 shows a schematic illustration of a method of the invention according to a variant of the embodiment MP allowing control of the aircraft to be returned to the pilot under certain conditions,

FIG. 5 shows a schematic illustration of a particular embodiment of the method of the invention.

In the figures, unless indicated otherwise, the elements are not to scale and identical references denote identical elements.

### DETAILED DESCRIPTION

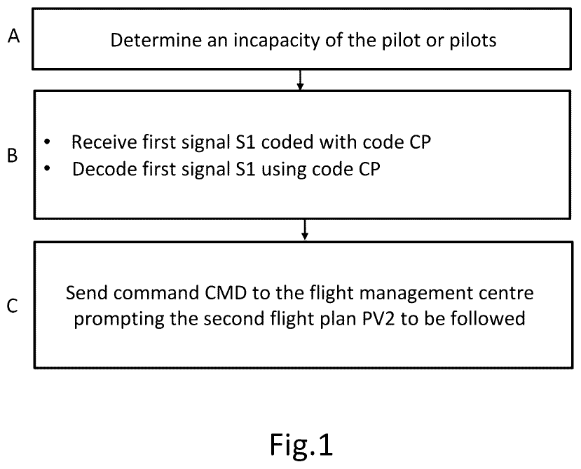

FIG. 1 schematically illustrates the method of the invention for remotely controlling the flight of an aircraft A in a secure manner.

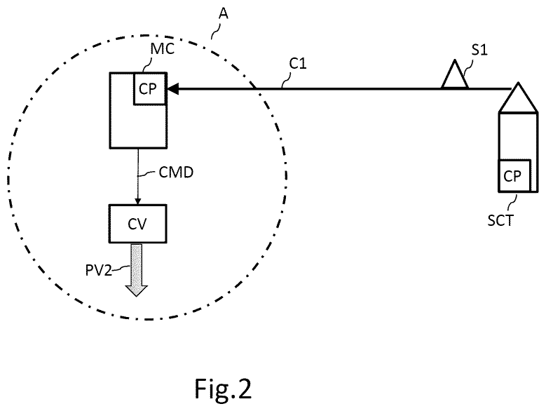

FIG. 2 schematically illustrates the communication module MC according to the invention, which is aboard the aircraft A and in particular suitable for implementing the method of the invention.

The communication module MC is connected to a flight management centre CV of the aircraft A. This communication module MC is suitable for allowing a communication between a terrestrial communication station SCT and the aircraft A by way of a channel C1.

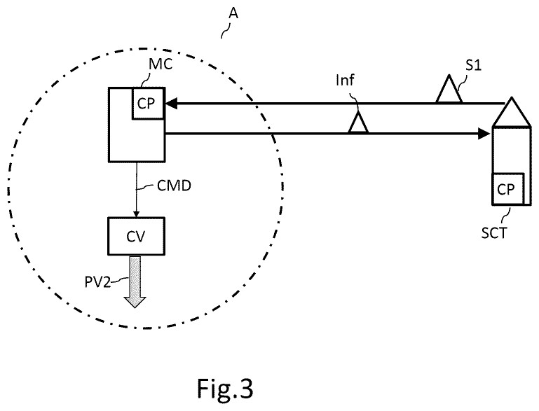

“Communication” is understood here to mean the exchange of a signal transmitted from the station SCT to the aircraft A and the interpretation of said signal in the form of a voice message, and/or a luminous message and/or graphical data, by the pilot or pilots of the aircraft. It is noted that, according to the invention, it is not strictly necessary for the module MC to be suitable for allowing a bilateral communication between the aircraft and the station SCT, although some embodiments allow such a bilateral communication (see in particular FIG. 3).

The terrestrial communication station SCT is for example an air traffic control (ATC) station or a terrestrial station associated with the airline responsible for the flight of the aircraft.

In the invention, this channel C1 is preferably a UHF, VHF or HF channel. According to various embodiments, the module MC may be a SELCAL (Selective Calling) module, a DATALINK module or a VHF voice communication module (see later).

In the remainder of the description, it is first assumed that the aircraft A is in flight and follows a first predetermined flight plan that has previously been filed and validated by the relevant authorities.

The method of the invention first comprises a step A of determining, in the terrestrial communication station SCT, an incapacity of the pilot or pilots of the aircraft.

According to one embodiment M1, the determination of the incapacity is performed directly by the terrestrial communication station SCT by collecting data related to the flight of the aircraft or to the communication or absence of communication with the aircraft. For example, this determination is performed on the basis of at least one piece of “flight parameter” information chosen from the following list: a heading of the aircraft, an altitude of the aircraft, a speed of the aircraft, an overflight of a prohibited area by the aircraft, an entry into a controlled or restricted area without authorization, a transmission of an emergency transponder code by the pilot, a loss of communication (voice or digital connection) between the communication station and the aircraft, an inability to establish a communication and a comparison of this information or these pieces of information against the first flight plan.

Thus, automatically or by observation by a user of the station SCT, the station SCT identifies an anomaly in respect of one or more flight parameters of the aircraft by comparison with the initially provided flight plan and infers, according to a previously established protocol, an incapacity of the pilot or pilots. This protocol is established before the aircraft takes off, and is approved for the operation of the aircraft.

Preferably, in the embodiment M1, the determination in step A is performed on the basis of a plurality of pieces of information about the flight parameters of the aircraft, which are observed or measured over a predetermined interval of time. Spreading the capture of information over time allows greater certainty in determining an incapacity of the pilot or pilots. For example, the duration of the interval of time is between several tens of seconds and a few minutes (but remains less than 5 minutes).

FIG. 3 illustrates an embodiment M2, which can be combined with the embodiment M1, in which the step of determination of the incapacity is performed on the basis of at least one piece of information Inf that is transmitted by the aircraft and representative of vital parameters of the pilot or pilots. Preferably, as illustrated in FIG. 3, the module MC is itself configured to transmit this information or these pieces of information. More precisely, the information or the pieces of information is or are representative of physical problems in the pilot or pilots. By way of nonlimiting example, these vital parameters are chosen from a list comprising: a heartbeat, an oxygen level, retinal analysis, an observation of body posture, a level of pressure on the controls or the seats, an absence of reaction to an event, a prolonged absence of reaction, the detection of an absence of brain activity.

Preferably, in the embodiment M2, the determination in step A is performed on the basis of a plurality of pieces of information Inf transmitted by the aircraft in a predetermined interval of time. Spreading the capture of information over time allows greater certainty in determining an incapacity of the pilot or pilots. For example, the duration of the interval of time is between 1 minute and 5 minutes.

After step A, the method of the invention comprises a step B of receiving, using the communication module MC, a first signal S1 that has been coded using a predetermined code CP and transmitted by the terrestrial communication station SCT. Moreover, in step B, the module MC is configured to decode the first signal S1 using the predetermined code CP.

The predetermined code CP is stored by the module MC and in the station SCT prior to the aircraft A taking off, for example when the first flight plan is filed. The nature of this code CP depends on the type of module MC used.

Thus, according to a first embodiment, the module MC is a SELCAL module. A SELCAL module is a selective calling system that allows a radio operator or an ATC controller at the station SCT to inform the crew of the aircraft A when he wishes to communicate with the plane. When the operator or the controller wishes to communicate with the aircraft while the crew is not monitoring the frequency (that is to say that the crew is not able to respond to a simple voice call from the operator or the controller), he selects the code CP (SELCAL code) of the module MC, which is available in the officially filed flight plan, and transmits it on the frequency monitored by the module MC. All aircraft monitoring the frequency receive the SELCAL alert that is broadcast but only the aircraft A programmed with the selected code CP then broadcasts a visual and/or audible alert in the cockpit.

Alternatively, according to a second embodiment, the module MC is a DATALINK module. Indeed, if the aircraft is already equipped with a capacity to communicate with air traffic control using DataLink, there is inherently the possibility of alerting the crew with the functional elements implemented in order to establish this flight-to-ground DataLink chain of communication, without necessarily resorting to a specific SELCAL module MC. Depending on the DataLink solutions used, an incoming signal (ground to flight) could be used to replace the SELCAL alert.

According to the first and second embodiments of the invention, the first signal S1 is received by the communication module MC by way of a communication channel C1 (specific in the first embodiment) between the aircraft and the terrestrial communication station SCT. In these embodiments, the channel C1 is protected by way of the predetermined code CP.

Alternatively, according to a third embodiment, the first signal S1 is received by the communication module MC by way of a clear communication channel C1 that is common to a plurality of other aircraft in order to communicate with the terrestrial communication station SCT. For example, this channel is a VHF channel for voice communication. In this third embodiment, the predetermined code is then a predetermined specific voice message and the first signal S1 is a voice message comprising the predetermined code CP. Moreover, the module MC comprises a processor suitable for performing voice recognition of the messages exchanged on the channel C1 so that, in step B, the decoding of the first signal S1 is then performed by voice recognition of the predetermined code CP included in the first signal S1.

After step B, the method of the invention comprises a step C of sending, using the communication module MC, a command CMD to the flight management centre CV prompting a second flight plan PV2 to be engaged and followed by the aircraft. Step C therefore prompts the activation of an emergency diversion function. This emergency function is activated remotely by the station SCT by way of the transmission of the first message S1.

Preferably, the second flight plan PV2 involves diverting the aircraft to have it land at a different airport, called the second airport, from a landing airport of the first flight plan, called the first airport. According to one embodiment, the second airport is the most appropriate airport to receive the aircraft, that is to say an airport allowing landing under sufficient safety conditions: accessibility (relief, weather), runway length and strength, emergency medical treatment for incapacitation, etc. According to another embodiment, the second airport is the most appropriate airport for the aircraft when step C is implemented.

According to one embodiment, the determination of the second airport in step C is performed on the basis of localization data provided by a localization sensor connected to the flight management centre and/or on the basis of data comprising airport selection criteria and appropriate mode of conduct of the aeroplane with regard to the second selected airport. For example, this localization sensor is a GNSS (Global Navigation Satellite System) receiver, a GPS receiver or a VOR (VHF Omnidirectional Range) sensor, or a DME (Distance Measuring Element) sensor. For example, the airport selection criteria comprise the aforementioned safety conditions.

The method of the invention has the advantage of allowing an emergency diversion function to be activated remotely by simply modifying a pre-existing communication module MC included in the aircraft. Indeed, implementing the method of the invention only requires the communication module MC to be connected to the flight management centre CV in order to allow the aircraft to be diverted after the first message S1 has been decoded by the module MC.

Critically, this diversion is possible only by decoding a message that has been coded using the predetermined code CP, this code being shared between the station SCT and the aircraft prior to takeoff. Thus, the emergency function may be activated remotely only by an authorized entity that has the code CP (the station SCT). The invention's remote activation of the emergency function is therefore secure.

According to one embodiment, the aircraft A comprises a single pilot. Indeed, the need to divert the aircraft remotely owing to pilot incapacitation is distinctly reduced when the aircraft A comprises multiple pilots, compared with when a single pilot is present. For example, it is not very likely that both pilots will simultaneously suffer physical problems (unless the latter are brought about by a common cause).

Preferably, the communication module is configurable to not implement step B after step A. The module is programmed so that this configuration can be implemented only before the aircraft takes off according to the first flight plan and/or the number of pilots in the aircraft. This embodiment allows conventional use of the communication module MC. “Conventional use” is understood here to mean that the exchange of the first signal S1 between the station SCT and the aircraft A does not cause the aircraft to be diverted to the second flight plan. This embodiment is in particular advantageous when the aircraft may alternatively comprise one or two pilots. If the aircraft comprises two pilots, and based on the first flight plan, it may be decided that implementing the emergency diversion function remotely is less relevant and that it is more advantageous to use the communication module MC for a message exchange function.

To clarify the wording, the embodiments will be described below by referring only to the case where a single pilot is present in the aircraft. However, it is understood that these embodiments apply to the case where the aircraft is piloted by two or more pilots.

According to one embodiment, denoted MP, the flight management centre CV is configured so that the pilot is unable to change a flight parameter of the aircraft during step C. This embodiment allows the pilot to be specifically prevented from being able to deliberately override the command CMD when inconsistent or inappropriate behaviour by the pilot has been detected by the station SCT.

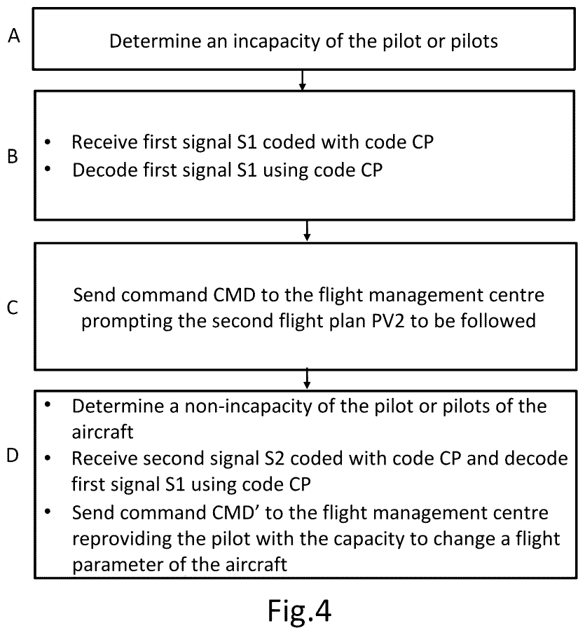

FIG. 4 schematically illustrates a variant of the embodiment MP allowing control of the aircraft to be returned to the pilot under certain conditions. The method in FIG. 4 comprises a subsequent step D that itself comprises multiple substeps.

In a first substep, the terrestrial communication station SCT determines a non-incapacity of the pilot of the aircraft. This first determination substep is implemented according to one of the various implementations described for step A of the method of the invention. For example, the first substep is carried out on the basis of at least one piece of information indicating a return to normal by one or more flight parameters of the aircraft by comparison with the initially provided flight plan, and/or restoration of the voice connection between the communication station and the aircraft, and/or at least one piece of information Inf that is transmitted by the aircraft and representative of a return to normal by certain vital parameters of the pilot.

Step D comprises a second substep, implemented by the communication module MC, of:
receiving a second signal S2 that has been coded using the predetermined code CP and transmitted by the terrestrial communication station SCT, and then
decoding the second signal using the predetermined code, which has previously been stored in the communication module.

This second substep is implemented according to one of the various implementations described for step B of the method of the invention.

Finally, step D comprises a third substep of sending, using the module MC, an additional command CMD′ to the flight management centre that involves reproviding the pilot with the capacity to change a flight parameter of the aircraft.

The method of the embodiment in FIG. 4 allows complete and definitive diversion of the plane to be prevented when certain vital parameters of the pilot and/or the flight parameters have been identified as restored. Thus, following step D, the pilot has the capacity to resume following the first flight plan (initial flight plan) that was temporarily interrupted in step C.

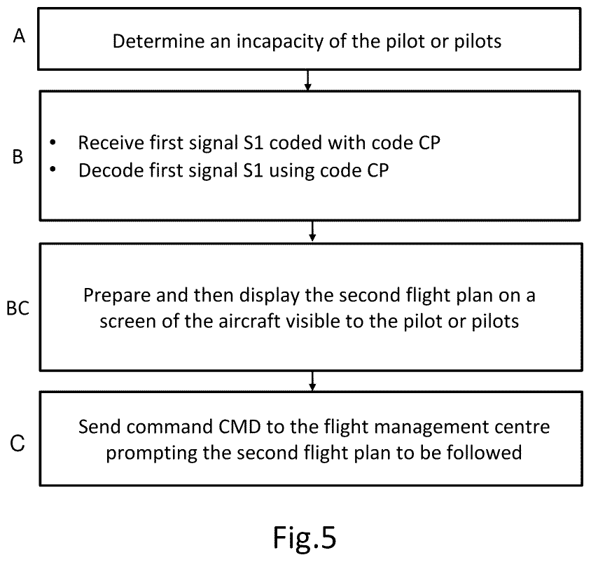

FIG. 5 schematically illustrates a particular embodiment of the method of the invention. In the embodiment in FIG. 5, the method comprises a step BC in between step B and step C of preparing and then displaying the second flight plan on a screen of the aircraft visible to the pilot. In this embodiment, step C is implemented after step BC only after a predetermined time. This predetermined time is typically from several seconds to a few minutes, but necessarily less than 5 minutes.

The embodiment in FIG. 5 allows the pilot to restore the flight parameter or parameters that had been considered to be abnormal in step A before the imminent implementation of the emergency diversion function. This is particularly useful when the pilot was not aware of the abnormal flight parameter or parameters of the aircraft, for example due to a fault in one or more flight instruments. If the pilot restores the flight parameter or parameters to normal with regard to the initial flight plan, the operator of the station SCT has the opportunity to not implement step C or to implement step D from FIG. 4 where appropriate in order to provide the pilot with the capacity to control the aircraft A.

Preferably, in step BC, a warning light and/or an audible alert that are perceptible by the pilot of the aircraft is/are activated in order to warn of the imminent implementation of the emergency diversion function. These alerts provide the pilot or pilots with the opportunity to make contact with the station SCT, and to cancel or retain engagement of the diversion procedure. For example, by seeing or hearing these alerts, the pilot will be able to restore the altitude or heading with regard to the values initially provided in the first flight plan or will be able to restore voice communication with the station SCT where appropriate.

Finally, another subject of the invention is an aircraft as illustrated in FIG. 2 or FIG. 3, comprising the flight management centre CV connected to the module MC.

1. A method for remotely controlling the flight of an aircraft (A) following a first flight plan, the aircraft comprising a communication module (MC) connected to a flight management centre (CV) of the aircraft, the communication module being suitable for allowing the exchange of a signal transmitted from a terrestrial communication station (SCT) to the aircraft and the interpretation of said signal in the form of a voice message, and/or a luminous message and/or graphical data, by the pilot or pilots of the aircraft, the method comprising the following steps:
A. determining, in the terrestrial communication station (SCT), an incapacity of the pilot or pilots of the aircraft,
B. using the communication module (MC), receiving a first signal (S1) that has been coded using a predetermined code (CP) and transmitted by the terrestrial communication station (SCT), and then decoding the first signal using the predetermined code, which has previously been stored in the communication module,
C. after the first signal (S1) has been decoded, sending, using the communication module, a command (CMD) to the flight management centre prompting a second flight plan (PV2) to be followed by the aircraft.

2. The method according to claim 1, wherein the second flight plan comprises landing the aircraft at a different airport from a landing airport of the first flight plan.

3. The method according to claim 2, wherein a determination of the second airport in step C is performed on the basis of localization data provided by a localization sensor connected to the flight management centre and/or on the basis of data comprising airport selection criteria and appropriate mode of conduct of the aeroplane with regard to the second selected airport.

4. The method according to claim 1, wherein the flight management centre is configured so that the pilot or pilots is/are unable to change a flight parameter of the aircraft during step C.

5. The method according to claim 4, comprising a subsequent step D of:
determining, in the terrestrial communication station (SCT), a non-incapacity of the pilot or pilots of the aircraft,
receiving, using the communication module (MC), a second signal (S2) that has been coded using the predetermined code and transmitted by the terrestrial communication station (SCT), and then decoding the second signal using the predetermined code, which has previously been stored in the communication module,
after having decoded the second signal (S2), sending, using the communication module, an additional command (CMD′) to the flight management centre that involves reproviding the pilot or pilots with the capacity to change a flight parameter of the aircraft.

6. The method according to claim 1, wherein the first signal is received by the communication module (MC) by way of an exclusive communication channel between the aircraft and the terrestrial communication station, the exclusive communication channel being protected by the predetermined code.

7. The method according to claim 1, wherein the first signal is received by the communication module (MC) by way of a clear communication channel (C1) that is common to a plurality of other aircraft in order to communicate with the terrestrial communication station (SCT), the first signal being a voice message comprising the predetermined code, the decoding of the first signal then being performed by voice recognition of the predetermined code included in the first signal.

8. The method according to claim 1, comprising a step BC in between step B and step C of preparing and then displaying the second flight plan on a screen of the aircraft visible to the pilot or pilots, step C being implemented after step BC only after a predetermined time.

9. The method according to claim 1, wherein the aircraft comprises a single pilot.

10. The method according to claim 1, wherein said determination of the incapacity is performed on the basis of at least one piece of information chosen from the following list: a heading of the aircraft, an altitude of the aircraft, a speed of the aircraft, an overflight of a prohibited area by the aircraft, a loss of communication between the communication station and the aircraft, or an incapacity to establish a communication.

11. The method according to claim 1, wherein said determination of the incapacity is performed on the basis of at least one piece of information (Inf) that is transmitted by the aircraft and representative of vital parameters of the pilot or pilots.

12. A communication module (MC) aboard an aircraft (A), said communication module (MC) being connected to a flight management centre (CV) of the aircraft and being suitable for allowing the exchange of a signal transmitted from a terrestrial communication station (SCT) to the aircraft and the interpretation of said signal in the form of a voice message, and/or a luminous message and/or graphical data, by the pilot or pilots of the aircraft, and being suitable for implementing the following steps when the aircraft follows a first flight plan:
A. receiving a first signal (S1) that has been coded using a predetermined code (CP) and transmitted by the terrestrial communication station (SCT), and then decoding the first signal using the predetermined code, which has previously been stored in the communication module,
B. after the first signal (S1) has been decoded, sending, using the communication module, a command (CMD) to the flight management centre of the aircraft prompting a second flight plan (PV2) to be followed by the aircraft.

13. The module according to claim 12, wherein the communication module is a SELCAL module or a DATALINK module.

14. The module according to claim 12, wherein the communication module (MC) is suitable for transmitting, to the terrestrial communication station (SCT), at least one piece of information (Inf) that is representative of an incapacity of the pilot or pilots of the aircraft.

15. The module according to claim 12, wherein, only before the aircraft takes off, the communication module is configurable to not implement step B after step A.
